(19) United States
(12) Patent Application Publication
(10) Pub. No.: US 2007/0131352 A1
(43) Pub. Date: Jun. 14, 2007

(54) Erect honeycomb fiber foam and its manufacturing method

(76) Inventor: Jeffery Wang, Shen Zhen City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/298,458

(22) Filed: Dec. 12, 2005

(51) Int. Cl. B32B 37/00

(52) U.S. Cl. 156/296; 156/62.2

(57) ABSTRACT

An erect honeycomb fiber foam and its manufacturing method that mix a highly contractible PET fiber with an elastic low melt PET fiber, open the fibers by an opening machine, card the fibers into a fiber net by a carding machine, cut the fiber net into a 90-degree continuous perpendicular and parallel fiber net by a cutting machine, and bake the fiber net in an oven by a hot wind such that the highly contractible PET fiber is crimp when heated and the elastic low melt PET fiber is melted and entangled with the highly contractible PET fiber. Layers of fibers of the fiber net are contracted to form a complex cellular form and give a stable elasticity, and the erect honeycomb fiber foam can be cut in a desired thickness. The present invention can replace the existing foam and is applicable for filtering, insulating heat, and absorbing sound.

### FIELD OF THE INVENTION

The present invention relates to an erect honeycomb fiber foam and its manufacturing method, and more particularly to an elastic erect honeycomb fiber foam that mixes a highly contractible fiber and a low melt fiber, opens the mixed fibers by an opening machine, cards the fibers into a fiber net by a carding machine, and stacks the fiber net into a 90-degree erect state by a cutting machine. The highly contractible fiber is heated to contract into a spiral shape and combined with a low melt fiber when the fiber becomes highly crimp, so that the stacked erect fiber layers are entangled into a complex cellular form like honeycomb, which are heated to solidify and form the erect honeycomb fiber foam.

### BACKGROUND OF THE INVENTION

The manufacturing method of traditional products such as sponges and foams is not related to the present invention. The method of manufacturing air through cotton simply forms a plane net cotton bed after carding the fibers, and places the cotton bed into a drying machine for shaping and formation. The product is a plane cotton object, which cannot provide a good elasticity.

In the present elastomer products, there is still no elastomer having a fiber structure, except chemicals that have a molecular structure such as sponges and foams. Undoubtedly, the elastomers having a fiber structure, particularly the structure of an erect cellular fiber net can meet the present strict requirements for environmental protection and recycling. Chemical fibers can be produced with different required physical properties by using different production technologies, and these physical properties including water absorbability, fire resistance, antiseptic capability, odor resistance, fiber length, crimp, change with temperature, coarseness (fineness), and softness (hardness) will cause changes to the fabric so produced. The properties of these fibers and an erect formation method are used to produce an elastomer with a significant elastic property.

In view of the description above, the present invention makes a plane net cotton bed by opening and carding the fibers, stacking the net cotton bed in a cutting process to form an erect net cotton bed, placing the erect net cotton bed into a drying machine to contract the net cotton bed into an erect honeycomb fiber foam by a hot wind. Therefore, the erect honeycomb fiber foam having high elasticity and resumability is produced to overcome the foregoing shortcomings.

### SUMMARY OF THE INVENTION

The primary objective of the present invention is to provide an erect honeycomb fiber foam and its manufacturing method.

To achieve the foregoing objective, the method of the present invention mixes two or more fibers: a low melt PET fiber and a self crimp PET fiber, and other fibers such as natural cottons, recycled fabrics, waste woven materials, old carpets, and recycled cottons, etc are added to comply with the different melting points of the two PET fibers according to the using purpose. After the fibers are mixed, the fibers are opened by an opening machine and sent to a carding machine to spread the mixed fibers into a continuous fiber net. The fiber net is sent to a cutting machine to cut the fiber net into 90-degree perpendicular and parallel stacked state, and sent to an oven for blow drying by a pressurized hot wind, so that the PET fiber becomes crimp when it is heated, and the PET fiber is melted and entangled with the erect low melt PET fiber to produce an erect honeycomb fiber foam having good elasticity and resumability. Further, various composition contents of fibers can be added to meet the required elasticity, and these fibers include natural cottons, recycled fabrics, waste woven materials, old carpets, and recycled cottons for adjusting the elasticity.

The objectives, features, and advantages of the present invention will become apparent in the following detailed description of the preferred embodiments with reference to the accompanying drawings.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a schematic view of an erect honeycomb fiber foam made by mixing two or more fibers according to the present invention;

FIG. 2 is a schematic view of the change of crimp of a highly crimp PET fiber of an erect honeycomb fiber foam at different temperatures according to the present invention; and

FIG. 3 is a schematic view of melting and connecting erect cotton layers of an erect honeycomb fiber foam according to the present invention.

### DETAILED DESCRIPTION OF THE PREFERRED EMBODIMENT

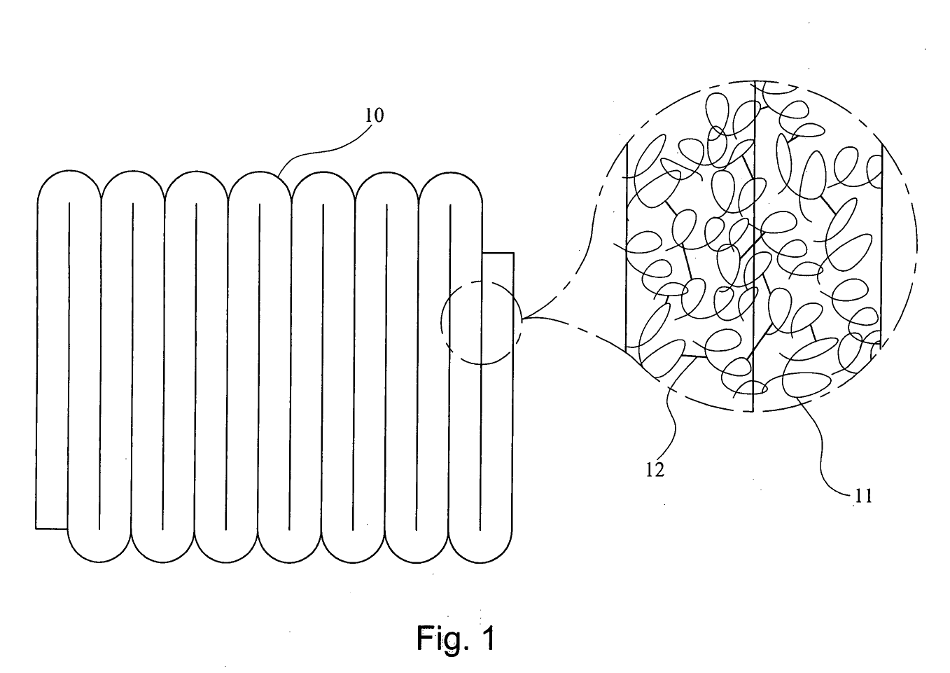

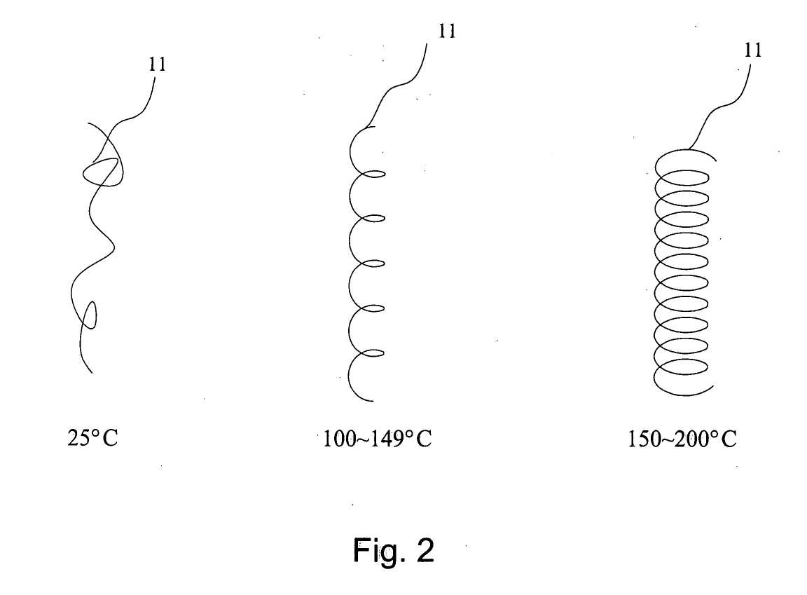

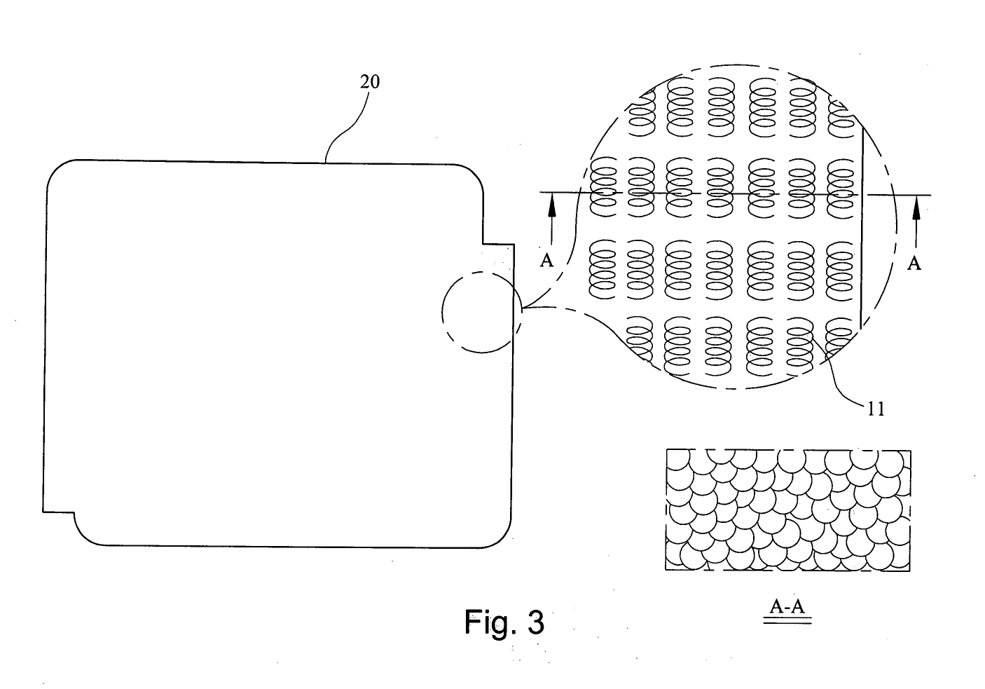

Referring to FIG. 1 for the enlarged view of a method for manufacturing an erect honeycomb fiber foam in accordance with the present invention, the invention mixes two or more fibers, wherein one is a low melt PET fiber 12 and the other one is a self crimp PET fiber 11, and another fibers may be added to these two basic fibers according to the using purposes, and these other fibers include natural cottons, recycled fabrics, waste woven materials, old carpets, and recycled cottons, etc. The two basic materials are mixed with different proportions according to the required elasticity, wherein the composition content of the low melt PET fiber 12 falls into a range of 30% to 70%, and the composition content of the self crimp PET fiber 11 falls in a range of 30% to 70%, and the composition content of other fibers fall in a range of 5% to 40%. After all fibers are mixed, the fibers are opened by an opening machine and then sent to a carding machine for spreading the mixed fiber into a continuous fiber net 10, so that the fibers are evenly distributed, and then the fiber net 10 is sent to a cutting machine and cut into a 90-degree perpendicular and parallel erect stacked state as shown in FIG. 1. Finally, the erect fiber net 10 is sent to an oven and baked by a pressurized hot wind, so that the self crimp PET fiber becomes crimp when it is heated. The change of the self crimp PET fiber 11 at different temperatures is shown in FIG. 2. The higher the temperature, the crimper is the fiber. The erect honeycomb fiber foam of a different crimp may have a different elasticity. The self crimp PET fiber 11 are melted and entangled with the low melt PET fiber 12 to form an erect honeycomb fiber foam 20 as shown in FIG. 3, wherein the highly contractible PET fiber 11 contained in each layer of fibers is contracted into a spiral form when it is heated, while the low melt fiber 12 is melted and entangled. The fibers 11 are highly crimp and evenly distributed. After the fibers are heated and solidified, the erect honeycomb fiber foam 20 having a cross-sectional cellular structure is formed as shown in the section A-A of FIG. 3, and this erect honeycomb fiber foam 20 could be an independent elastomer having good ventilation, plasticity, elasticity, and resumability. The erect honeycomb fiber foam made of the chemical fibers comes with a consistent elasticity and a resumability and also complies with the requirements for environmental protection. In the entire manufacturing process, the produced fiber waste can be used repeatedly in the foregoing manufacturing process, and thus there is no waste material issue. The entire process also adds no chemicals at all, and thus no chemical contamination is involved in the production.

The erect honeycomb fiber foam of the invention can be cut into a desired thickness and used for various different articles requiring an elastomer, such as chair cushions, insoles, mattresses, crashproof protective materials for replacing the existing foams. The invention also can use its cellular structure for absorbing sound and insulating heat, etc. The erect honeycomb fiber foam can be used further as a filter for filtering impurities evenly and absorbing impurities into the erect honeycomb fiber foam.

The composition content of the low melt PET fiber 12 according to the preferred embodiment of the invention falls into a range of 45% to 50%, and the composition content of the self crimp PET fiber 11 falls into a range of 45% to 50%, and other fibers fall into a range of 5% to 10%. The ranges meet the specifications for the manufacturing process for manufacturing the erect honeycomb fiber foam.

In a preferred embodiment of the present invention, two or more fibers are mixed and carded. Two or more fibers are mixed according to the following proportion and then opened by an opening machine, and sent to a carding machine for carding the fiber into a continuous fiber net. The proportion of the mixed fibers by weight is given as low melt PET fiber/self crimp PET fiber/other fibers=(45-50%)/(45-50%)/(5-10%).

In the process of cutting and baking fibers, the continuous fiber net 10 is cut into a 90-degree perpendicular and parallel continuous stacked form by a cutting machine and then sent to an oven and blew dry by a pressurized hot wind. The fibers are contracted into a spiral form when they are heated, and when the fiber becomes highly crimp, the PET fibers 11 are engaged with each other in a spiral form and evenly distributed when they are heated, so that the low melt PET fiber 12 is melted and solidified to form an erect honeycomb fiber foam 20. The erect honeycomb fiber foam 20 can replace the existing foam and used for related applications such as chairs cushions and mattresses. The erect honeycomb fiber foam can be wrapped by other materials for the applications of insulating sound and absorbing heat, and thus the erect honeycomb fiber foam of the invention is valuable to the industry.

While the invention has been described by means of specific embodiments, numerous modifications and variations could be made thereto by those skilled in the art without departing from the scope and spirit of the invention set forth in the claims.

While we have shown and described the embodiment in accordance with the present invention, it should be clear to those skilled in the art that further embodiments may be made without departing from the scope of the present invention.

1. A method for manufacturing erect honeycomb fiber foam, comprising the steps of:
(a) mixing two or more fibers according to a predetermined proportion, where one of said two or more fibers is a self crimp PET fiber in an amount of 45%-50% by weight
(b) opening said fibers by an opening machine,
(c) sending said fibers to a carding machine for carding said fibers into a continuous fiber net;
(d) processing said continuous fiber net into a 90-degree perpendicular and parallel continuous stacked state by a cutting machine, and
(e) sending said continuous fiber net into an oven for dry blowing by a pressurized hot wind, so that said two or more fibers are melted, entangled, and solidified into an erect honeycomb fiber foam.

2. The method of claim 1, wherein said fibers include a low melt PET fiber.

3. (canceled)

4. The method of claim 1, wherein said fibers add a natural cotton, a recycled fabric, a waste woven material, an old carpet, or a recycled cotton according to a required elasticity.

5. The method of claim 2, wherein said low melt PET fiber has a composition content of 45% to 50%.

6. (canceled)

7. The method of claim 4, wherein said other fibers have a composition content of 5% to 10%.
